(19) United States
(12) Patent Application Publication
(10) Pub. No.: US 2005/0265365 A1
(43) Pub. Date: Dec. 1, 2005

(54) Ring bearing network and method of implementing service bearing thereof

(76) Inventor: Huaixue Wan, Shenzhen (CN)

Correspondence Address: Richard P. Berg, ESQ.;c/o LADAS & PARRY, Suite 2100, 5670 Wilshire Boulevard, Los Angeles, CA, 90036-5679, US

(21) Appl. No.: 11/128,111

(22) Filed: May 11, 2005

(30) Foreign Application Priority Data
May 12, 2004 (CN) 200410034777.6

(51) Int. Cl. H04L 12/56

(52) U.S. Cl. 370/401; 370/395.4

(57) ABSTRACT

The present invention discloses a ring bearing network and a method of implementing service bearing thereof; said ring bearing network comprises a plurality of network nodes and physical links or logical links connected the network nodes, designed to bear service data at different nodes in a manner of label switched path; said method of implementing service bearing based on said ring bearing network comprises: scheduling multi protocol label switching service data at the node onto said ring bearing network with a predetermined scheduling algorithm at the service source node; multiplexing the service data at different nodes in the same physical link or logical link in a manner of label switched path for transporting; scheduling the respective service data in said physical link or logical link off said ring bearing network at the service destination node. The present invention can make service processing in ring network simpler and more efficient, implement cross-ring service data interconnection and protection, and improve bandwidth utilization ratio of the rings.

### FIELD OF THE INVENTION

The present invention relates to the technical field of service bearing in network communication, particularly to a ring bearing network and a method of implementing service bearing thereof.

### BACKGROUND OF THE INVENTION

As communication service bearing network technologies develop, new generations of metropolitan area bearing network technologies emerges endlessly; wherein, Resilient Packet Ring (RPR) technology, characterized by technical sophistication, effectiveness of investment, superior performance, and extensive support to services, provides a good solution for metropolitan area bearing networks.

RPR network is a bearing network generated on the basis of requirements of packet-based metropolitan area network; it is a ring network composed of packet switching nodes, with adjacent nodes connected through a pair of reverse physical paths; its network topology is based on two reverse transmission rings, wherein, the ring that transmits data in clockwise is called outer ring, the ring that transmits data in counterclockwise is called inner ring.

RPR is a Media Access Control (MAC) layer technology, which optimizes data services transport on ring topology, and is adaptive to diverse media on physical layer, and can effectively transport different types of data, e.g., voice, image and so on. It combines economical efficiency, flexibility, and scalability of Ethernet technology and 50 ms fast protection of Synchronous Digital Hierarchy (SDH) ring network, with functions including automatic network topology detection, ring bandwidth sharing, fair bandwidth allocation, and strict Class of Service (COS), etc.

However, RPR technology has its limitations: IEEE802.17 only defines the RPR MAC layer technology designed for a single physical ring or logical ring (a Virtual Container (VC) channel across multiple SDH physical rings), but RPR uses a dedicated frame format, which can not be identified by any other device outside of the RPR network; therefore, RPR is not a total solution for the entire network and is only applicable to single ring networking; in cross-ring scenarios, it has to be terminated with R-MAC (Resilient Packet Ring-Media Access Control) and can not provide end-to-end bandwidth sharing, fairness mechanism, or Quality of Service (QoS) assurance and protection for inter-ring services. As the result, a Multi-Service Provisioning Platform (MSPP) with purely embedded RPRs has certain limitations on topology when it is used to establish a complex network and has to be supplemented with other technologies to provide end-to-end service provision.

At present, a general solution is to introduce Layer-2/Layer-3 switches at entries/exits of rings and between rings to implement service data interconnection between RPRs, which increases network complexity and makes network structure unclear. Another solution is to overcome RPR's disadvantages with MPLS over RPR; however, this approach introduces two protocol layers: RPR layer and Multi Protocol Label Switching (MPLS) layer, as shown in FIG. 1, which increases complexity of service data processing and network Operation Administration and Maintenance (OAM), and degrades processing efficiency; in addition, due to the special frame format of RPR, introduction of MPLS layer will increase overhead on each data packet and thereby degrade utilization efficiency of network bandwidth.

### SUMMARY OF THE INVENTION

An object of the present invention is to provide a ring bearing network and a method of implementing service bearing thereof, for implementing ring network in a simple and effective way, resolving interconnection and protection of service data across rings, and improving bandwidth utilization efficiency of ring network.

To this end, the present invention provides the following technical solution:
A ring bearing network, comprising: a plurality of network nodes, designed to send service data to the ring bearing network or receive service data from the ring bearing network; physical links or logical links connecting the individual network nodes, designed to transmit service data between the network nodes;
The encapsulation format of the service data received or sent by said network nodes is standard multi protocol label switching frame format;
Said physical links or logical links bear service data between the network nodes in a manner of label switched path.

Alternatively, said nodes adapt the service data to be sent into said physical links directly through generic framing procedure, point-to-point protocol or High-level Data Link Control (HDLC), or directly bear the service data into the logical links.

A method of implementing service bearing in ring bearing network, comprising the following steps:
A. at the service source node, scheduling multi protocol label switching service data at the node onto said ring bearing network with a predetermined scheduling algorithm;
B. multiplexing the service data at different nodes in the same physical link or logical link in a manner of label switched path for transporting;
C. scheduling the respective service data in said physical links or logical links off said ring bearing network at the service destination node.

Said step A further comprises:
at the service source node, scheduling the multi protocol label switching service data at the node onto said ring bearing network with a strict priority scheduling algorithm.

Said step of scheduling multi protocol label switching service data at the node onto said ring bearing network with the strict priority scheduling algorithm comprises:
A1. at said service source node, performing flow classification on the service data scheduled onto the local ring;
A2. filling the experiment field of multi protocol label switching frame according to the classification level of flow;
A3. scheduling said local service data scheduled onto the ring to different egress port queues and onto the ring bearing network according to the classification level of flow indicated by said experiment field.

Said step A2 further comprises:
filling the experiment field of multi protocol label switching frame according to priority field of Virtual Local Area Network service data and/or Class of Service field of internet protocol service data and/or priority assigned by the administrator.

Said step B comprises:
B1. establishing a label switched path required as per said multi protocol label switching service;
B2. adapting said multi protocol label switching service data into the physical link corresponding to said label switched path directly through generic framing procedure, point-to-point protocol, or high-level data link control, or adapting said multi protocol label switching service data directly into the logical link corresponding to said label switched path.

Preferably, said method also comprises the following step:

D. controlling the data sending rate from the individual nodes to said ring bearing network with an algorithm for controlling fairness of the bandwidth.

Said step D comprises:
D1. establishing a dedicated label switched path between two adjacent nodes in said ring bearing network to transport the protocol data information of the algorithm for controlling fairness of the bandwidth;
D2. observing utilization of the links connected with the node in said ring bearing network, and notifying the observed results to all nodes in the ring bearing network;
D3. each node in said ring bearing network adjusting data sending rate from the node to said ring bearing network according to said algorithm for controlling fairness of the bandwidth and the obtained notice.

Alternatively, said method also comprises: at said service source node, encapsulating non-multi protocol label switching service data into multi protocol label switching service data according to predetermined rules.

Said predetermined rules further comprise: classifying non-multi protocol label switching service data packets into different forwarding equivalent classes according to destination address, and inserting the respective labels into the packet headers according to the forwarding equivalent classes of the packets, and thereby accomplishing multi protocol label switching encapsulation; or
classifying non-multi protocol label switching service data packets into different forwarding equivalent classes according to Quality of Service requirement, and inserting the respective labels into the packet headers according to the forwarding equivalent classes of the packets, and thereby accomplishing multi protocol label switching encapsulation.

Said method also comprises: implementing service data transmission across rings through cross-ring label switched paths.

Alternatively, said method also comprises: employing 1:1 and/or 1+1 label switched path protection for inside-ring and cross-ring service data.

Preferably, said method also comprises: employing ring switching protection and/or source route protection for said ring bearing network.

Alternatively, said method also comprises: establishing a dedicated LSP between two adjacent nodes on the ring to transport the protocol data information of algorithm for controlling fairness of the bandwidth.

Alternatively, said method also comprises: establishing a dedicated LSP between two adjacent nodes on the ring to transport automatic network topology discovery protocol information.

It can be seen from above technical solution of the present invention that the ring bearing network of the present invention not only has all functions of the RPR network, but also provides the following advantages when compared to RPR network: it doesn't perform Media Access Control, and therefore it is simpler in processing and improves processing efficiency of data transmission and utilization efficiency of bandwidth of ring network; since it employs standard MPLS frame format, the service data format is independent of the ring network, and therefore cross-ring end-to-end service provision as well as ringlet interconnection in the case of multi-ring intersecting/inter-tangent can be implemented in the ring bearing network of the present invention without any auxiliary technology; since MPLS encapsulation technology is employed on the ring bearing network, different QoS parameters can be assigned for different Label Switched Paths (LSPs), and therefore more Service Level Agreements (SLAs) can be supported, differentiated QoS can be assured and supported better through scheduling LSP granularity with pre-negotiated QoS parameters; furthermore, the Operation And Maintenance (OAM) functions, including LSP Connectivity Verification (CV), LSP Fast Failure Detect (FFD), Forward Defect Indication (FDI), and Backward Defect Indication (BDI), etc., in MPLS can be utilized fully.

### BRIEF DESCRIPTION OF THE DRAWINGS

FIG. 1 is a schematic diagram of the hierarchy in which a Resilient Packet Ring (RPR) is located in a Multi-Service Provisioning Platform (MSPP);

FIG. 2 is a schematic diagram of the hierarchy in which the ring bearing network of present invention is located in a MSPP;

FIG. 3 shows the topology of the ring bearing network according to the present invention;

FIG. 4 is the flowchart of the method of implementing service bearing on the basis of the ring bearing network according to the present invention, as shown in FIG. 3;

FIG. 5 is an implementation diagram of scheduling ring service data onto/off according to the present invention;

FIG. 6 is an implementation diagram of scheduling cross-ring service data onto/off according to the present invention;

FIG. 7 is an implementation diagram of protection for cross-ring service data according to the present invention.

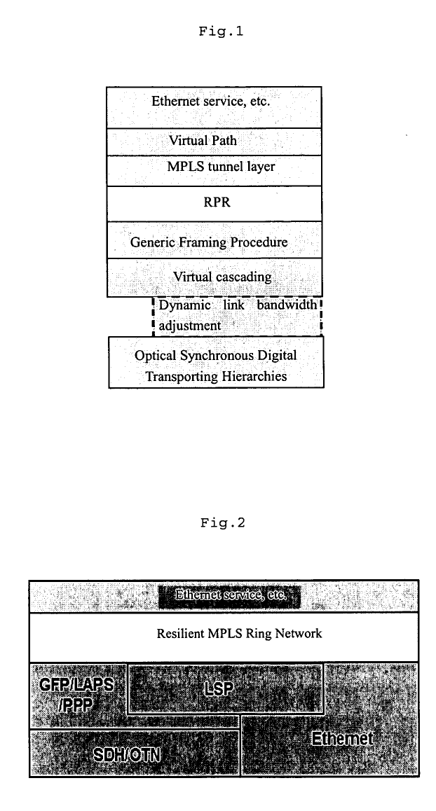

### DETAILED DESCRIPTION OF THE EMBODIMENTS

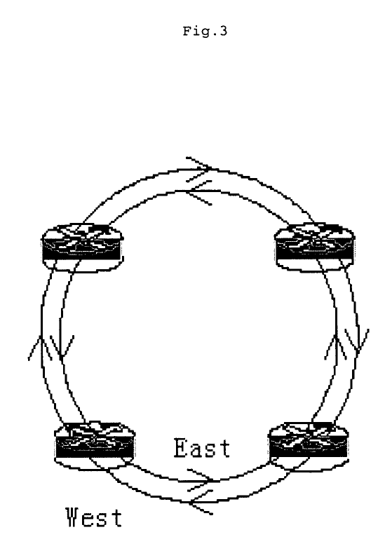

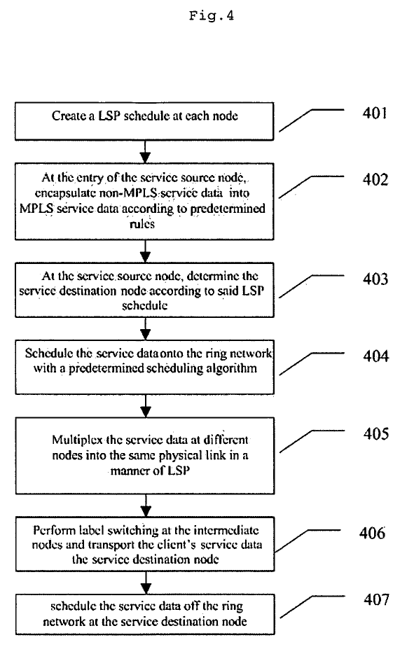

The core of the present invention is to establish a ring bearing network (resilient MPLS ring network) directly at the Multi Protocol Label Switching (MPLS) layer, independent of the Resilient Packet Ring (RPR) layer; the hierarchy in which the ring network is located in the MSPP is shown in FIG. 2; the ring network is independent of the physical layer; it may employ different physical layer technologies as required or be borne directly on logical links. The network topology of the ring network is shown in FIG. 3, comprises a plurality of network nodes and employs a double-ring structure, composed of a west ring and an east ring; wherein, the west ring transports service data in clockwise, while the east ring transports service data in counter clockwise; different nodes are connected with each other through physical links, for bearing client service data between them in a manner of label switched path; said nodes receive or transmit data encapsulated in standard Multi Protocol Label Switching (MPLS) frame format, and adapt the transmitted service data into said physical links directly through Generic Framing Protocol (GFP), Point-to-Point Protocol (PPP), or High-Level Data Link Control (HDLC), or bear the transmitted service data directly onto logical links. It is unnecessary to redefine the frame format for the ring network; instead, the ring network uses standard MPLS frame format to transmit client's service data; service data at different nodes is multiplexed into a physical link (e.g., Synchronous Digital Hierarchy (SDH)/Optical Transporting Networks (OTN)) or a logical link (e.g., Label Switched Path (LSP)) in a manner of label switched path.

To enable those skilled in the art to understand the solution of the present invention better, hereinafter the client's service data transport flow through the ring bearing network is detailed with reference to the flowchart in FIG. 4, comprising the following steps:

Step 401: creating a label switched path scheduling at each of the network nodes. The label switched path schedule contains information on label action, destination port, etc., the label actions including pop up label, push label, and swap label. Said schedule may be created through static configuration, or created and maintained through Label Distributing Protocol (LDP)/Resource Reservation Protocol (RSVP) or a combination of the both above.

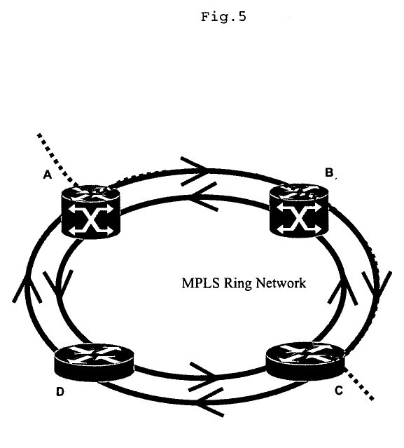

Step 402: at the entry of the service source node, encapsulating non-multi protocol label switching service data into multi protocol label switching service data according to predetermined rules. The detailed process is shown in FIG. 5, in which the ring network comprises 4 nodes: A, B, C, and D. At the entry of the source node A, classifying service data packets in non-multi protocol label switching format into different Forwarding Equivalent Classes (FECs) according to predetermined rules; inserting respective labels into packet headers according to forwarding equivalent classes of the packets, and thereby accomplishing multi protocol label switching encapsulation. Said predetermined rules are specified by subscribers, e.g., classifying non-MPLS service data according to destination address or Quality of Service (QoS) requirement, etc. If the client's service data itself is MPLS packets, this step may be omitted;
Step 403: at the service source node, obtaining the service destination node according to said label switched path schedule. The detailed process is: after performing the label actions (pop up label, push label, swap label) according to the label switched path schedule, finding out the egress port and obtaining the service destination node;
Step 404: scheduling the service data onto the ring network with a predetermined scheduling algorithm;
for instance, scheduling the service data onto the ring network with strict priority scheduling algorithm, so as to provide better service level for the client;
first, performing flow classification on the local service data scheduled onto the ring and filling the experiment (EXP) field of MPLS frame according to the classification level of flow, the classification level of flow comprising priority of Virtual Local Area Network (VLAN) service data and/or type of Internet Protocol (IP) service data and/or priority specified by the administrator;
then, scheduling the local service data scheduled to the ring to different egress port queues and onto the ring network according to classification level of flow indicated by said experiment field.

Of course, any other scheduling algorithm, e.g., Weighted Round Robin (WRR) scheduling algorithm, may also be used as required.

Step 405: multiplexing the service data at different nodes in the same physical link or logical link in a manner of label switched path for transporting;
first, establishing a LSP required as per the MPLS service; then, adapting the MPLS service data to the physical link corresponding to the LSP directly through Generic Framing Procedure (GFP), Point-to-Point Protocol (PPP), or High-level Data Link Control (HDLC) protocol, etc., or bearing the MPLS service data directly into the logical link.

Step 406: performing label switching at the intermediate nodes to transport the client's service data to the service destination node; for instance, in FIG. 5, after label switching at the intermediate node B, forwarding to the next node C quickly.

Step 407: scheduling the service data off the ring network at the service destination node; referring to FIG. 5, at the destination node C, after searching in the label switched path schedule table, determining the node as the destination node of the label switched path, and scheduling the client's service data off the ring network, and performing respective processing on the client layer.

The ring bearing network of the present invention transports client's service data in standard MPLS frame format, and makes the service data format independent of the ring bearing network; therefore, any device outside of the ring bearing network can identify subscriber frames from the ring network without any processing. As a result, the cross-ring end-to-end service provision as well as service data interconnection in the case of multi-ring intersecting/inter-tangent can be achieved conveniently.

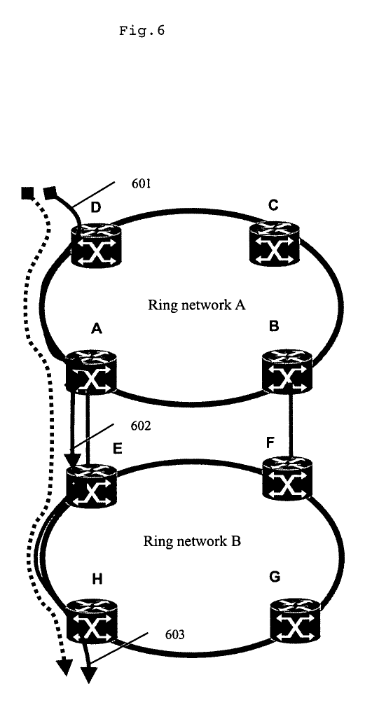

FIG. 6 is an implementation diagram of scheduling cross-ring service data onto/off the ring bearing network of the present invention:

There is a service data flow across ring networks A and B of the present invention; wherein ring network A comprises 4 nodes: node A, B, C and D, and ring network B also comprises 4 nodes: node E, F, G and H. 601 is the actual path of the service data flow in ring network A; 602 is the actual inter-ring path of the service data flow; and 603 is the actual path of the service data flow in ring network B. In implementation, the paths 601, 602, and 603 correspond to one LSP respectively, i.e., the LSP from node D to node A in ring network A: LSP1, the LSP from node E to node H in ring network B: LSP3, and another LSP from node A to node E between ring network A and B: LSP2; at node A and node E, label switching from LSP1 to LSP2 and from LSP2 to LSP3 is implemented respectively.

It can be seen that the cross-ring service data can be scheduled through MPLS LSP scheduling, both inside and between the ring networks, without other conversions.

In the case of multi-ring intersecting/inter-tangent, the cross-ring service data transporting process is similar to the above, and will not be described further.

To ensure better normal network operation, the present invention also takes the following protection measures for the ring bearing network:

1. LSP-Based Protection (Label Switched Path Protection)

(1) Protection of Inside-Ring Service Data: Implementing 1:1 or 1+1 LSP Protection with MPLS Operation Administration and Maintenance (OAM) Function.

In detail, it is as follows: the working LSP and the protecting LSP are configured in reverse to each other (e.g., the working LSP is configured in the west ring; and the protecting LSP is configured in east ring); for 1:1 mode, the working LSP is in working state and the protecting LSP is not in working state, and in case the working LSP fails, detecting the failure with MPLS OAM function in time, and then activating the protecting LSP for service data transmission; for 1+1 mode, both the working LSP and the protecting LSP are both in working state, and in case the working LSP fails, detecting the failure with MPLS OAM function in time, and then transferring the service data from the working LSP to the protecting LSP to transport.

(2) Protection of Cross-Ring Service Data: Implementing 1:1 or 1+1 LSP Protection with MPLS OAM Function.

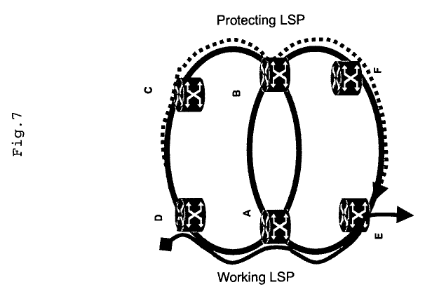

As shown in FIG. 7, the working LSP and the protecting LSP are across the different links of intersecting rings; for 1:1 mode, the working LSP is in working state and the protecting LSP is not in working state, and in case the working LSP fails, detecting the failure with MPLS OAM function in time, and activating the protecting LSP for service data transmission; for 1+1 mode, both the working LSP and the protecting LSP are in working state, and in case the working LSP fails, detecting the failure with MPLS OAM function in time, and then transferring the service data from the working LSP to the protecting LSP to transport.

The MPLS OAM function mentioned above is described in brief as follows:

MPLS OAM frame formats are defined in ITU-T Rec.Y.1711; at present, there are 6 types of the defined frames: Connectivity Verification (CV), Fast Failure Detect (FFD), Forward Defect Indication (FDI), Backward Defect Indication (BDI), performance message, loop back request, and loop back response; however, only CV, FDI, and BDI are defined with explicit format and operating procedure.
(a) Connectivity Verification: CV flow is generated at the source Label Switching Router (LSR) of LSP, transmitted at a speed of 1/S, and terminated at the destination LSR of LSP; the CV message carries the network-unique Trail Termination Source Identifier (TTSI), thus settling the basis of detecting all defects.
(b) Forward Defect Indication: FDI message is generated in response to failure detection behavior (e.g., defect from CV flow), mainly designed to suppress network alarms on the layers above the layer where the error is detected;
(c) Backward Defect Indication: BDI flow is inserted in the return path (e.g., a return LSP), designed to notify defects detected at the destination node of the downlink LSP to the uplink LSR (source node of the forward LSP).

2. Network-Based Protection

(1) Ring Switching Protection (Wrap):

In detail, it is as follows:
1. the network nodes exchange topology information with each other through automatic network topology detection signaling, so that each node knows the whole network state;
2. in case that a segment is broken in the ring network, the nodes at both ends of the broken point will detect defect information and location of the fault;
3. the nodes at both ends of the broken point will send control signaling along the ringlet to notify individual nodes;
4. the nodes adjacent to the defect points will loop back the service data, respectively;
5. during ring protection switching, switching service data to the reverse LSP channel in sequence according to the service level of service data. In this way, even if the protection for lower layer of network is unavailable, the ring switching protection approaching to SDH/SONET layer can be affected.

(2) Source Route Protection (Steering)

In detail, it is as follows:
1. topology information is exchanged between the network nodes through signaling, each node knowing the whole network state;
2. in case that a segment is broken in the ring network, the nodes at both ends of the broken point will send control signaling to notify the information of affected LSP to other nodes;
3. when the respective source node of LSP receives the information, it will redirect the LSP to the other direction of the ring immediately, so as to implement source route protection.

To provide better Quality of Service to client's service, the present invention utilizes the experiment (EXP) field in MPLS label (the field is not defined of usage in the standard, it comprises 3 bits, usually used for priority, and can support up to 8 priorities). Different QoS parameters can be assigned for different LSPs, so that more Service Level Agreements (SLAs) can be supported; differentiated QoS can be further assured and supported through scheduling LSP granularity with pre-negotiated QoS parameters. In detail, the process is as follows:
1. at the service source node, performing flow classification on the local service data scheduled onto the ring;
2. filling the EXP field of MPLS frame according to the classification level of flow:
a) performing MPLS encapsulation on non-MPLS service data flow. Determine the value of the EXP field of MPLS frame with a certain algorithm, for instance, perform flow classification on the service data flow by the information such as pri (priority) field of Virtual Local Area Network (VLAN) service data (the field comprises 3 bits, which can support up to 8 priorities) and/or Type Of Service (TOS) field of Internet Protocol (IP) service data (the field identifies the type of IP service, e.g., video service) and/or priority provided by the administrator, etc., or combinations thereof, as required. For instance, if the TOS field is of video service and the priority of VLAN is high, it is defined as the first priority; if the priority of VLAN is relatively low, it is defined as the second priority, and so on;
b) for MPLS service flow, choosing to use existing EXP field or reassign an EXP field as required;
c) EXP field filling is only for local service flow scheduled onto the ring and uses the same algorithm for all nodes on the ring;
3. according to the classification level of service data flow indicated by the EXP field, scheduling the client's service data to different egress port queues;
4. scheduling different priority queues to the egress port with a certain algorithm and method (e.g., scheduling algorithm, such as strict priority scheduling algorithm), i.e., scheduling them onto the ring network for transmission.

Due to the fact that the bandwidth of the ring bearing network is shared, network congestion is easy to occur in case of bandwidth oversubscribed at an individual node or by an individual client. Therefore, in the ring bearing network of the present invention, information of service data flow bandwidth is collected from the individual nodes through signaling and the service data scheduled onto the ring at the individual sites are controlled with a certain algorithm for controlling fair bandwidth, so that each site can access the ring bandwidth fairly. In detail, the process is as follows:
1. establishing a dedicated LSP between two adjacent nodes on the ring to transport the protocol data information of algorithm of controlling fairness of the bandwidth;
2. observing the utilization of the immediately adjacent link on the Resilient MPLS Ring (RMR) layer at each node all along and then notifying the information to all nodes on the ring;
3. the ring network executing the algorithm for controlling fairness of the bandwidth with an internal mechanism (depending on the algorithm for controlling fairness of the bandwidth used), to control utilization of bandwidth fairness; the algorithm for controlling fairness of the bandwidth is a mechanism that enables every client to share the bandwidth of the ring fairly; unlike SDH/SONET transport network, which allocates a fixed bandwidth to each client, the algorithm for controlling fairness of the bandwidth allocates the full bandwidth of the ring to clients as a global resource; each node can know the data amount that is permitted to transmit to the ring according to the result of the algorithm for controlling fairness of the bandwidth;
4. establishing a feedback mechanism, which adjusts data sending rate from the source node to the network according to the result of the previous step, and thereby implements fair access to the ring bandwidth.

It can be seen that the ring bearing network of the present invention not only inherits all advantages of RPR network, but also delivers more advantages; for instance, simpler service data processing, higher efficiency, cross-ring end-to-end service provision, service data interconnection in the case of multi-ring intersecting/inter-tangent, more Service Level Agreements (SLAs) supported, and full utilization of MPLS OAM functions, etc.

Though the present invention is described with reference to the embodiments, it is understood by those skilled in the art that there may be many variations and changes made to the present invention without departing from the spirit of the invention; however, any of such variations and changes shall fall into the protection scope of the present invention as defined by the claims.

1. A ring bearing network, comprising: a plurality of network nodes, designed to send service data to the ring bearing network or receive service data from the ring bearing network; physical links or logical links connecting the individual network nodes, designed to transmit service data between the network nodes;
wherein
the encapsulation format of the service data received or sent by said network nodes is standard multi protocol label switching frame format;
said physical links or logical links bear service data between the network nodes in a manner of label switched path.

2. The ring bearing network according to claim 1, wherein said nodes adapt the service data to be sent into said physical links directly through generic framing procedure, point-to-point protocol or high-level data link control, or directly bear the service data into the logical links.

3. A method of implementing service bearing based on the ring bearing network of claim 1, comprising the following steps:
A. scheduling multi protocol label switching service data at the node onto said ring bearing network with a predetermined scheduling algorithm at the service source node;
B. multiplexing the service data at different nodes in the same physical link or logical link in a manner of label switched path for transporting;
C. scheduling the respective service data in said physical link or logical link off said ring bearing network at the service destination node.

4. The method according to claim 3, wherein said step A further comprises:
scheduling the multi protocol label switching service data at the node onto said ring bearing network with a strict priority scheduling algorithm at the service source node.

5. The method according to claim 4, wherein said step of scheduling multi protocol label switching service data at the node onto said ring bearing network with the strict priority scheduling algorithm comprises:
A1. performing flow classification on the service data scheduled onto the local ring at said service source node;
A2. filling the experiment field of multi protocol label switching frame according to the classification level of flow;
A3. scheduling said local service data scheduled onto the ring to different egress port queues and onto the ring bearing network according to the classification level of flow indicated by said experiment field.

6. The method according to claim 5, wherein said step A2 further comprises:
filling the experiment field of multi protocol label switching frame according to priority field of virtual local area network service data and/or class of service field of internet protocol service data and/or priority designated by the administrator.

7. The method according to claim 3, wherein said step B comprises:
B1. establishing a label switched path required as per said multi protocol label switching service;
B2. adapting said multi protocol label switching service data into the physical link corresponding to said label switched path directly through generic framing procedure, point-to-point protocol, or high-level data link control, or adapting said multi protocol label switching service data directly into the logical link corresponding to said label switched path.

8. The method according to claim 3, also comprising the following step:
D. controlling the data sending rate from the individual nodes to said ring bearing network with an algorithm for controlling fairness of the bandwidth.

9. The method according to claim 8, wherein said step D comprises:
D1. establishing a dedicated label switched path between two adjacent nodes in said ring bearing network to transport the protocol data information of the algorithm for controlling fairness of the bandwidth;
D2. observing utilization of the links connected with the node in said ring bearing network, and notifying the observed results to all nodes in the ring bearing network;
D3. each node in said ring bearing network adjusting data sending rate from the node to said ring bearing network according to said algorithm for controlling fairness of the bandwidth and the obtained notice.

10. The method according to claim 3, also comprising:
encapsulating non-multi protocol label switching service data into multi protocol label switching service data according to predetermined rules at said service source node.

11. The method according to claim 9, wherein said predetermined rules comprises:
classifying non-multi protocol label switching service data packets into different forwarding equivalent classes according to the destination address, and inserting the respective labels into the packet headers according to the forwarding equivalent classes of the packets, and thereby accomplishing multi protocol label switching encapsulation; or
classifying non-multi protocol label switching service data packets into different forwarding equivalent classes by quality of service requirement, and inserting the respective labels into the packet headers according to the forwarding equivalent classes of the packets, and thereby accomplishing multi protocol label switching encapsulation.

12. The method according to claim 3, also comprising:
implementing service data transmission across rings through cross-ring label switched paths.

13. The method according to claim 3, also comprising:
employing 1:1 and/or 1+1 label switched path protection for inside-ring and cross-ring service data.

14. The method according to claim 3, also comprising:
employing ring switching protection and/or source route protection for said ring bearing network.

15. The method according to claim 3, also comprising:
establishing a dedicated LSP between two adjacent nodes on the ring to transport the protocol data information of algorithm for controlling fairness of the bandwidth.

16. The method according to claim 3, also comprising: establishing a dedicated LSP between two adjacent nodes on the ring to transport automatic network topology discovery protocol information.
